(19) United States
(12) Patent Application Publication
(10) Pub. No.: US 2003/0101417 A1
(43) Pub. Date: May 29, 2003

(54) Method and data processing system for coordinating applications of a computer software

(76) Inventor: Bernd J. Hobrack, Biberach (DE)

Correspondence Address: Shlesinger Arkwright & Garvey, 3000 South Eads Street, Arlington, VA, 22202, US

(21) Appl. No.: 10/181,939

(22) PCT Filed: Feb. 5, 2001
(86) PCT No.: PCT/EP01/01199

(30) Foreign Application Priority Data
Feb. 4, 2000 (DE) 100 04 809.9
Feb. 21, 2000 (EP) 00103697.9

(51) Int. Cl. G06F 15/00

(52) U.S. Cl. 715/517

(57) ABSTRACT

This invention relates to a method for coordinating at least two applications of a computer software that can be opened either dependently or independently. According to the inventive method, information allocated to a first application is highlighted depending on information or information fields of a second application that are highlighted and/or being processed.

The present invention relates to a method of coordinating at least two openable applications of a piece of computer software as well as a data processing system and a computer programme.

In numerous data processing applications it is necessary to input information supplied on paper into a data processing system. Conventionally this is done by an operator working as a user of a personal computer, operating a dialogue-oriented application to detect “real” process data. The operator transfers the data into a process and data model of unspecified complexity on which the processing operation is based.

Conventionally, work of this kind could only be done in a highly non-ergonomic way, as constant head movements were needed in order to read the information on the piece of paper and input the data into the corresponding fields on the screen of the personal computer.

The term “real” information here denotes all the knowledge which is needed in order to determine the properties and characteristics of said processing operation and to be able to make the relevant decisions necessary for undertaking the processing steps envisaged by the application. Examples might include the transfer of data from an insurance purchaser, who has entered his details on an insurance application form, into a computer programme which processes insurance applications of this kind.

To simplify such activities it is known to scan the papers containing the data and thus make the documents available in digitalised form. Digitalised documents of this kind can be displayed on screen for example in “image format”.

To make the work easier it is known to open a graphic area of the document which has been scanned in as a first window and at the same time to open the dialogue-oriented application as a second window on a screen. With screens of conventional or economical size it is not possible to display the entire scanned document in a legible size, with the result that only partial graphic areas of the image are displayed (views). The user therefore has to bring the areas of the scanned document which interest him into the display area one after another. This is traditionally done using the so-called scroll function, e.g. using keystrokes or mouse commands.

The user's task is therefore to transfer the “real” information from the scanned-in document into the dialogue-oriented application so that the data can be processed in DP-assisted processes. It is also possible to use such information in order to alter DP-stored data by means of the dialogue-oriented application.

The need to scroll manually through the scanned-in document so that the desired areas appear in the viewing window has proved in practice to be very laborious and is also a source of errors which should not be underestimated.

The problem of the invention is therefore to provide a method, a data processing system and a computer programme with which the manual transferring of information or data from a first application into at least one second application is easier than with conventional solutions.

This problem is solved by a method having the features of claim 1, a data processing system having the features of claim 5 and a computer programme having the features of claim 9.

The selective highlighting of information, envisaged according to the invention, from the information displayed within the scope of the first application greatly simplifies the work of a user or operator in transferring this information into a second application, compared with conventional solutions, because of the ergonomic coordination of the two applications thus provided. Related activities can also be carried out with less effort; for example the comparison of information relating to the same process but present in different applications or formats. When the present invention is used, moreover, monitors can be made substantially smaller.

Advantageous embodiments of the method according to the invention, the data processing system according to the invention and the computer programme according to the invention are recited in the sub-claims.

According to a first preferred embodiment of the method according to the invention or the system according to the invention, a first application of the computer software is the graphic display of a digitalised or scanned-in document, and a second application is a dialogue-oriented application for inputting and/or reproducing and/or processing information regarding the digitalised document. This makes it possible, for example, to present a scanned-in document in a first application in partial view on a screen, while the dialogue-oriented application can be displayed on the same screen. By suitably highlighting the appropriate information in the digitalised document it is much easier to input or transfer the corresponding information into dialogue boxes.

According to a preferred embodiment of the method according to the invention, the information from the first application is selectively highlighted by being automatically positioned, in particular, in a central part of a window which is generated by the first application. This provides, to some extent, automation of the traditional scroll function. According to the invention it is ensured that, depending on the information highlighted in the second application, the corresponding area of information of the first application is positioned in a window of the first application in such a way that it is easily visible to the user. It should be pointed out that the highlighting of information envisaged according to the invention can also be achieved in any other suitable way. For example, particularly in the case of larger windows in which correspondingly larger parts of a digitalised document are visible, it is possible to highlight the relevant areas in colour or by some other means. It is also possible to zoom in on the areas of interest in an enlarged window of this kind so that the surrounding information is partly covered but is still at least partly recognisable.

Appropriately, the information or information fields of the second application are highlighted by means of a focus, especially a cursor, and/or a speech-controlled focus, while, in particular, semantic context areas of the information or information fields can be used and/or defined by the user. In this way, information or information fields of the second application can easily be highlighted or marked, so that the corresponding, associated information of the first application can be highlighted accordingly. Here, too, other possible ways of highlighting are conceivable. For example, it would be possible to mark or highlight corresponding information or information fields by putting them in a box.

Thus it is possible to receive user input regarding the second application by means of mouse, keystroke or voice-activated commands. It has also proved advantageous to define semantic context areas of specific focussed information or focussed information fields so that the user is provided with a workstation configuration or desktop which is particularly easy to view.

Preferred embodiments of the method according to the invention or of the data processing system according to the invention will now be described in more detail with reference to the accompanying drawings, wherein:

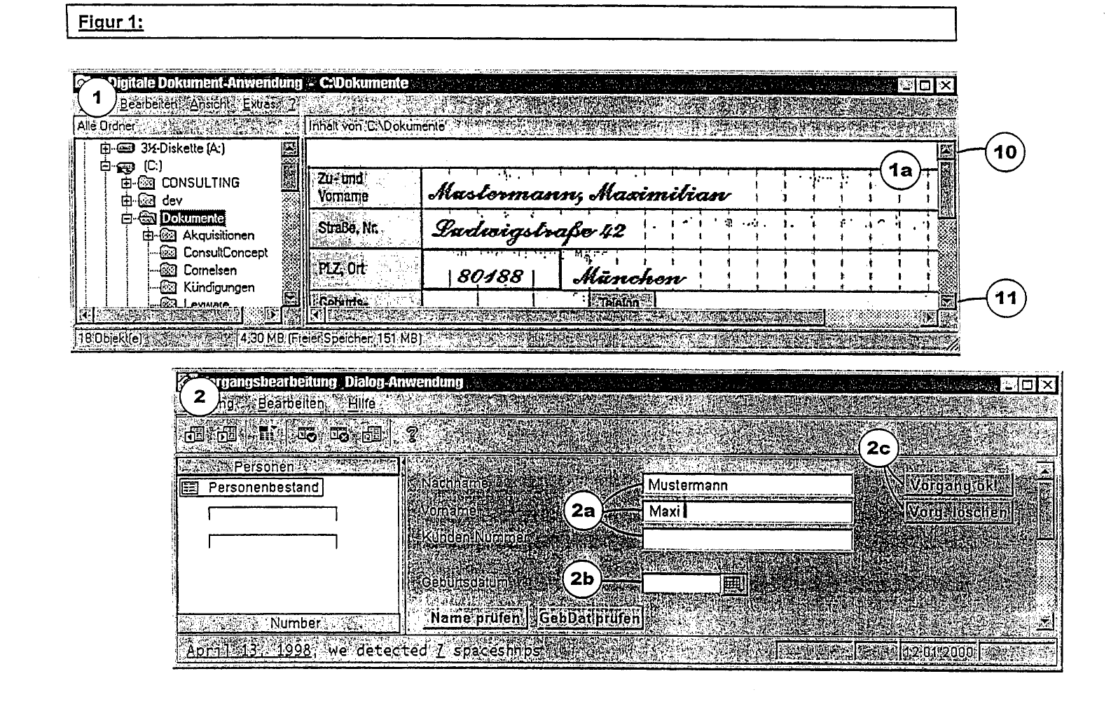

FIG. 1 shows a first preferred embodiment of a user desktop with which the method according to the invention can be carried out,

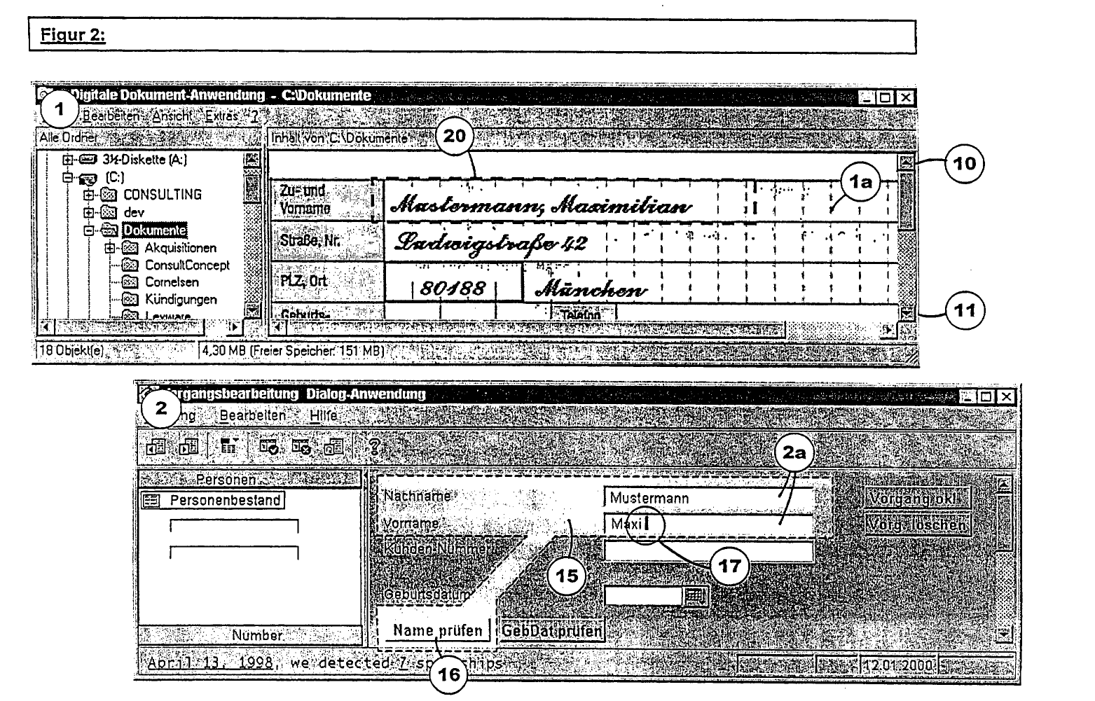

FIG. 2 shows the view in FIG. 1, indicating possible ways of highlighting the information in question,

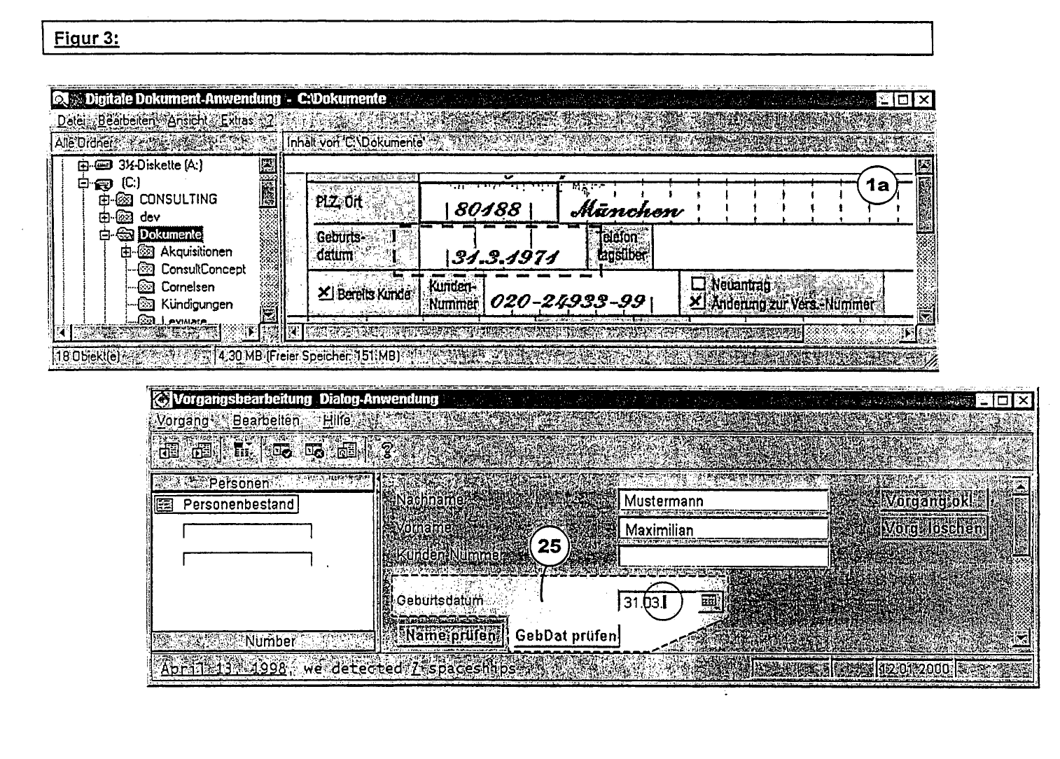

FIG. 3 is a view corresponding to FIG. 1 but with other parts of the information of the particular applications highlighted,

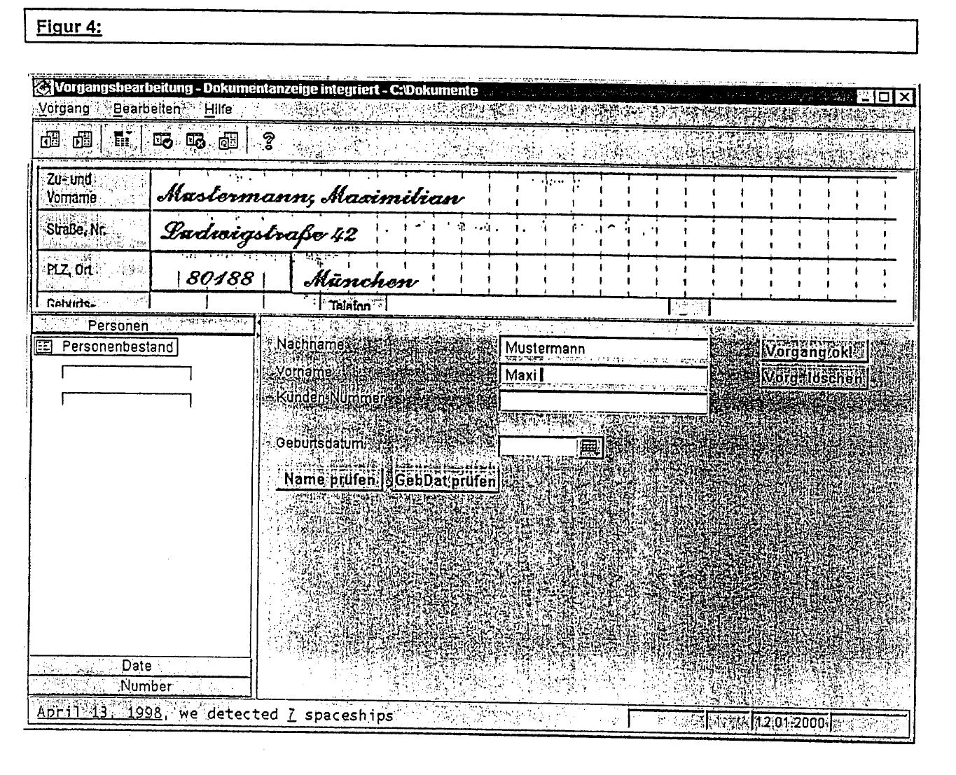

FIG. 4 is a second preferred user desktop on which the method according to the invention can be used,

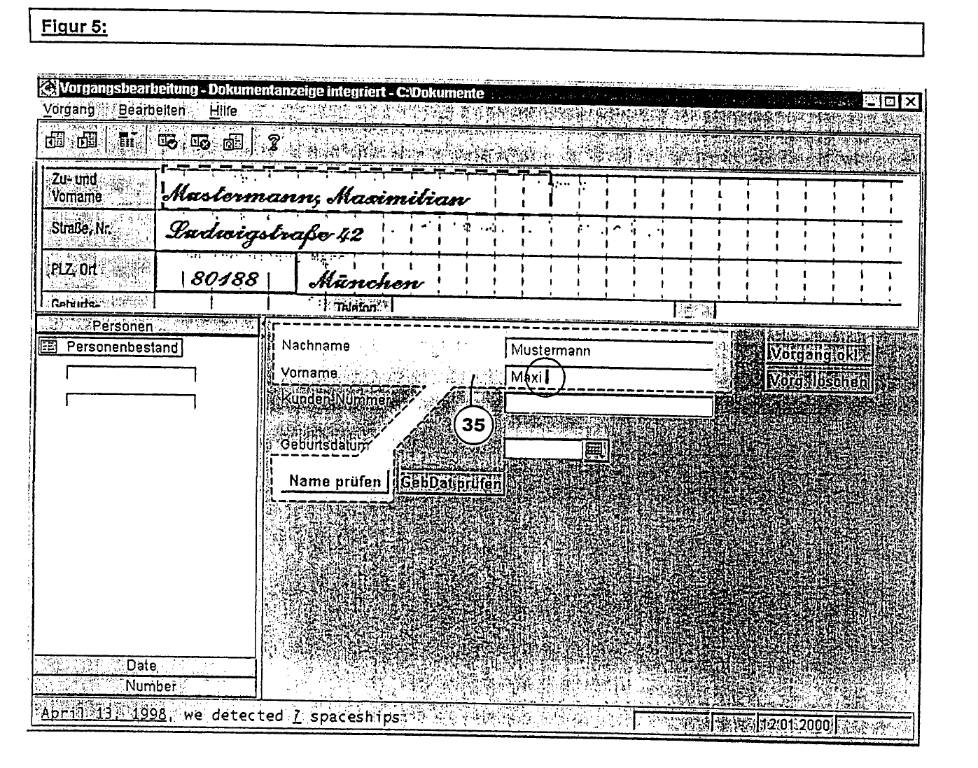

FIG. 5 shows the view in FIG. 4, indicating possible ways of highlighting the information in question, and

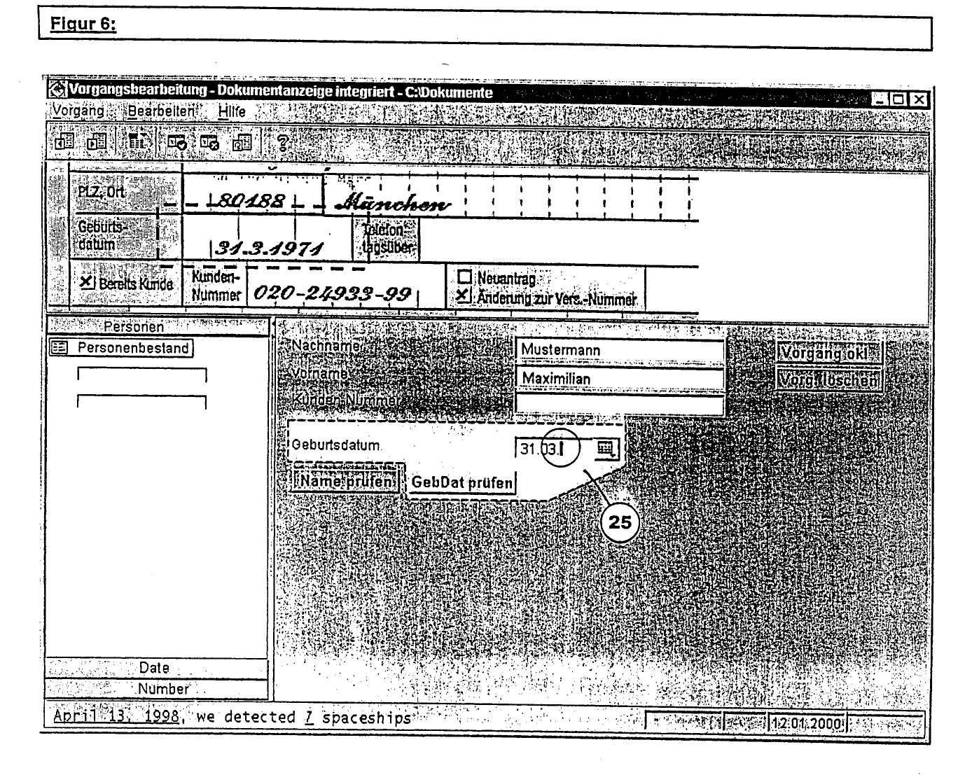

FIG. 6 is a view corresponding to FIG. 3 of the second preferred user desktop.

FIG. 1 diagrammatically shows a user desktop displayed to the user on the screen of a computer system. It will be seen that there are two applications 1, 2 open. Application 1 shows in a window 1a (so-called “view”) a section of a digitalised document. For reasons of clarity it is assumed that the document is an application, filled in by hand, for a state benefit or for an insurance. Obviously, any other documents may be conceivable or may be displayed in scanned form.

The window 1a shown contains the name and address of the applicant. The user of the computer system is now given the task, for example, of inputting the data entered in the window 1a into the second open application which, in this instance, is a dialogue-oriented application. It will be seen that the name has already been partly input. The dialogue-controlled application 2 has data fields 2a, 2b and control elements, so-called buttons 2c. As the user's task is to input the information from the first application into the second application, the latter is to some extent the main application of the processing operation.

If the user now wants to enter, for example, the applicant's date of birth in data field 2b, the problem arises that this information does not appear in the displayed screen section 1a of application 1. Traditionally the user was compelled in such cases to scroll through the document by, for example, clicking on the scroll buttons 10, 11 of the first application in order to position the desired information relating to the date of birth in the window area 1a. This has proved in practice to be very difficult to take in at a glance, tedious and labour-intensive, and therefore the present invention sets out to automate this scrolling process, for example, as will be explained hereinafter. It is also possible, using the process according to the invention, to check any data contained in the second application 2 by means of the scanned-in document of application 1, as will also be explained hereinafter.

The process according to the invention will now be explained by way of example with reference to FIG. 2. The aim of the invention is to relate information areas or semantic context areas of the particular applications 1, 2 to one another, so that when an information area in one of the two applications is brought up the corresponding information area in the other application is automatically displayed or made available to the user.

A semantic context area of this kind is designated 15 in FIG. 2 and highlighted by means of a lighter shading. The highlighting with a lighter shading may, if desired, be displayed on screen, but this is not necessary.

If the user now clicks on the control element 16 “Check name”, the system recognises the context area associated with this control element and relates it to a corresponding context area of the scanned-in document in the window 1a of the first application 1. A context area can also be brought up, for example, by placing a cursor 17 in a corresponding data field 2a without clicking on the control element 16. Context areas can to some extent be defined or called up inductively (calling up an individual element of a context area) or deductively (calling up a control element which designates the context area overall). A particularly simple form of a context area may be an individual information field, for example the field 2a “Surname” (“Zuname”), which in this case can clearly be assigned to the displayed field “Surname and first name” (Zu-und Vorname”) in the scanned-in document.

Another application of the use of context areas envisaged according to the invention consists, for example, in the fact that when focussing or clicking on the information field “Surname”, for example, a subsequent click on the control element 16, which is assigned to the same semantic context area as the information field “Surname”, causes a data bank running in the background to be called up.

As described, the user thus declares, by actuating a control element (e.g. button 16) or a cursor 17, a semantic context area, i.e. a group of data fields and control elements which can be focused or highlighted on the desktop of his dialogue application, which are advantageously closely related to one another in meaning and/or can also be found close together spatially in the (digitalised) scanned-in forms.

As an alternative to an individual declaration the user can take the necessary data for activating the context area from a configuration data bank in which the dialogues and forms used with declaration data are stored, and use them for the process according to the invention. Suitable software instruments can assist the user in the individual declaration and in adding to and managing the configuration data banks.

With regard to the cursor, it should be pointed out that this may be, for example, the blinking cursor which is known from numerous applications with a graphic user desktop in the editable data fields (such as 2a) and/or it may be the focus on a control element or a button.

As already mentioned, the user can define an information area in the window of the application 1 (e.g. by adding a box with a dotted outline) and thereby involve the coordinates which are important for functional centring as a context-relevant counter-pole to the semantic context area. This definition should be such that the information appearing on the form corresponds more or less appropriately to the “meaning” of the context area. This interpretation and assessment is appropriately up to the user himself. Presets in the base configuration data bank are excepted. Suitable software instruments can assist the user with the definition.

The automatic positioning of the desired information area of the scanned-in document of application 1 in the window 1a can be achieved for example by assigning each information area of the second application a specific area of a form which is the basis of the document to be scanned in. When calling up an information area in the second application it is then readily possible, for example, with suitable software, to establish an associated area of the scanned-in area of the first application and to position this associated area in the window 1a. The procedure to some extent provides a hyperfocus in the sense of an overlapping focus between two information areas with different data formats.

Conversely, it is also possible, for example, to manually position the desired information section of the scanned-in document in the window 1a by operating the scroll buttons 10, 11. This graphically fixes the information area which is to be viewed. By reverse assignment of a corresponding information area of the second application, by means of the software, the display of the second application with which the user is confronted can then be adjusted accordingly. In the event of any ambiguity the system can suggest a choice of suitable dialogue forms.

The system shown provides, overall, a semantic hyperfocus between two semantic context areas of two different applications. The focussing possibilities provided by the cursor 17 or scrolling process (“graphic focus”), for example, are to be understood as being mentioned purely by way of example.

The automatic positioning of the desired information section in the window 1a or the corresponding calling up of the information areas of the application 2 constitutes a highlighting with in the sense of the patent claims. It should be noted that highlighting may also take other forms, e.g. highlighting in colour and/or bold type and/or zooming of the relevant parts of the scanned-in document. The latter procedure is of interest, for example, when larger areas of the scanned-in document are displayed in the window 1a or when larger screens are available which allow larger windows 1a to be displayed.

It should be pointed out that it is appropriately up to the user to decide whether or not he wants to use the process according to the invention, the “semantic hyperfocus”. Obviously, the option of switching the process on or off should also be available.

Without manual intervention and unnoticed by the user it is possible, using the process according to the invention, to record the cursor movements through the dialogue forms of the dialogue application 2, so that when a declared semantic context area is reached it is possible to carry out a corresponding search and re-positioning of the visible display area of the scanned-in document in the window 1a of the first application. The software provided uses the coordinates and/or parameters of the form or the dialogue application defined above and calculates from them the optimum position of the relevant information for the user, taking into account graphic format data of the document and the display options of the window 1a (“view”) available for the display.

The method according to the invention thus automatically combines two data sets or pieces of information presented in different formats for the user.

If the user then places the cursor in the data field 2b “Date of birth” (“Geburtsdatum”), for example, the process according to the invention recognises the change implicitly involved, which moves the cursor beyond the boundary of the semantic context area 15, and immediately positions the new context-relevant extract from the form (with graphic focus) in the window of the first application 1.

Thus, the user always has before him, in his field of vision, the part of the digitalised form in which he is interested with the context-relevant information, without always having to search for new positions by manual movements.

It should be noted that the highlighted areas shown here, such as the area 15, are marked purely to make the drawing clearer. They may be configured freely as the user chooses or they may be wholly or partly faded out.

The context area assigned to the date of birth is designated 25 in FIG. 3. It is also apparent that the area of the scanned-in document containing the corresponding information is positioned in the window 1a. As the processing operation continues, the user has other context-relevant information in his field of vision without any effort on his part, resulting solely from the movements of the conventional cursor, which he is able to read off comfortably. Obviously, the user can choose a configuration to select the zoom factor with which he would like to enlarge or reduce the graphic display of the digitalised document to enable him to work at an optimum level.

FIGS. 4 and 5 show another embodiment of a user desktop with which the method according to the invention can be carried out.

According to this embodiment, only one application window 1 is open on the desktop of a computer screen. It should be noted that the applications 1, 2 described in FIGS. 1 to 3 are combined here in a single application window. It would be possible to designate this combined application as a single application, in which case it would be a question of two functionalities of one application. In this respect the term “application” used within the scope of the present disclosure can also be interpreted as “functionality”. The graphic display component which, as a further application, was assigned to a separate application window in the embodiment described above is in this case implemented as an integral part in the window of the dialogue-based application. In this way the information on the digitalised form is displayed to the user in a graphic window or display area (“view”) of the same application window. Here, the user is constantly obliged to intervene, because of the possibly tighter constraints on space, to find new positions for viewing sections. The manual interventions would also be made, as in the prior art, by keystroke commands or using a mouse.

FIG. 5 shows, as in FIG. 2, a semantic context area 35 which correlates with the part of the scanned-in form that contains the requisite information, analogously to the first embodiment described in detail hereinbefore, and thus integrates the processing.

To sum up, the most important properties of the method according to the invention (semantic hyperfocus) can be summarised once again: The method according to the invention connects types of information provided in different forms by means of correlated display areas which are capable of being configured and programme-flow-controlled. The method according to the invention is a software-ergonomic tool, from the user's point of view, and is constructed as a software module for dialogue-controlled applications. For display and presentation on the user desktop the method according to the invention may adopt or use various graphic elements such as pointers, circles or boxes, of different shapes, inter alia.

The method according to the invention integrates two hitherto independent components, namely the graphic focus and the conventional processing or cursor focus. The latter is included only indirectly as it acts as a passive signalling means within the semantic context areas. The semantic context area is a group of data fields and switching buttons which can be focussed with the cursor, for example, in the dialogue application, and thus provides a focus-correlated connection to the user-controlled focus activity in the processing operation.

The method according to the invention can be configured as desired, for example, for a scanned-in document by means of position coordinates and graphic cursor coordinates associated therewith. Both absolute and relative coordinate data may be used as well as various coordinate systems.

In the semantic context area the quantity of focusable data fields and switching buttons can be freely configured.

The configuration can be stored in a configuration data bank when general and standardised form formats with specific application dialogue forms (dialogues) are used.

If necessary, the method according to the invention can be activated or deactivated by the user. Because of its positional logic and functionality the method according to the invention is capable of automatically re-positioning a visible display area (section) of the scanned-in document (via the position coordinates) as soon as the user, in the course of processing, moves his processing or cursor focus into a different semantic context in the dialogue application.

The method according to the invention is also capable of carrying out reverse positionings (semantic positionings) or proposing processing positions in the dialogue applications in the event of ambiguities in the assignment. This means, for example, that by using the graphic focus in the viewer application (i.e. the view of the scanned-in document) the user can be moved back into a corresponding dialogue application with an active processing and cursor focus.

The obvious benefit to the user of the method according to the invention is having access to a substantially improved ergonomic integration of the various data formats in which paper-based process information can be made more productive by digitalisation and merging at the user workstation (rationalisation towards digital processing).

The solution according to the invention is thus characterised in that two types of information (associated with different applications) can be linked simultaneously and in parallel manner by means of a novel software element. Data types and data structures specific to the application are detected or modified, while application-specific graphic objects in standard graphic format for example are used and displayed as an information source, e.g. in a bitmap, tif or JPEG format.

When the method according to the invention is activated the appropriate form section of a digitalised document is moved into the field of vision with the context-relevant information, without the user having to activate this by his own efforts.

If the user makes changes in the semantic context area using the normal processing and cursor focus, the behaviour of the graphic focus is controlled as a reacting component by the method according to the invention. If the user makes changes in the digitalised document using the graphic focus the behaviour of the normal processing and cursor focus in the semantic context area is controlled as a reacting component by the method according to the invention. Through the activation of the method according to the invention there is a (polar) connection of the data structures with graphic formats via the conventional user interfaces of a PC.

By means of the method according to the invention or the software used to carry it out it is possible to connect configured, programme-flow-controlled and conceptually related display areas (graphic focus area and semantic context area) of two applications.

The method implements a recording logic to detect any focus or cursor movements into another semantic context area which may occur. The method is capable of implementing a calculating logic for re-positioning and optimising the display of the particular contents of the information which are relevant. Using the method, repositioning (of the document or of the semantic context area) takes place automatically as soon as the user engaged in the processing moves his processing and cursor focus in the dialogue application into another semantic context area (reaction of the graphic focus). Conversely, the method is capable of reversing positions or of proposing processing positions in the dialogue applications in the event of ambiguities of assignment. The method is capable of converting the recording logic used for recognition and calculating logic for re-positioning even when the normal processing and cursor focus is moved by voice control into another semantic context.

By using the invention it is possible, in particular, to manually transfer information which has been entered in manuscript on a form (subsequently scanned in) into a dialogue-oriented computer application. It has proved particularly beneficial that information areas or information fields of the particular applications can be assigned to one another without the need for actual information or text recognition by means of a computer.

It should be pointed out that a distinction must be drawn in information technology between data structures which are to be viewed as variables (in this case the information fields) and their contents (in this case information or information values). The assigning of variables of different applications has proved to be substantially less laborious than the assigning of information or information values. The process according to the invention can therefore be carried out even when, for example, the form scanned in and/or the dialogue fields of the dialogue-oriented application are empty and contain no entries.

List of German terms used in FIGS. 1 to 6 and respective English translations:

| FIG. 1: | Digitale Dokument-Anwendung: | | digital document application |
|---|---|---|---|
| | Dokumente: | | documents |
| | Bearbeiten: | | edit |
| | Ansicht: | | view |
| | Alle Ordner: | | all files |
| | Inhalt von: | | contents of |
| | Diskette: | | disc |
| | Akquisitionen: | | acquisitions |
| | Kündigungen: | | notices |
| | Zu- und Vorname: | | surname, first name |
| | Straβe, Nummer: | | street, no. |
| | PLZ, Ort: | | ZIP-Code, town |
| | Objekt(e): | | object(s) |
| | Freier Speicher: | | free storage area |
| | (Vor)gangsbearbeitung: | | action processing |
| | Dialog-Anwendung: | | dialog application |
| | Personen; | | persons |
| | Personenbestand: | | list of persons |
| | Nachname: | | surname |
| | Vorname: | | first name |
| | Kundennummer: | | client no. |
| | Geburtsdatum: | | date of birth |
| | Name prüfen: | | check name |
| | Geb.dat. prüfen | | check date of birth |
| | Vorgang ok: | | action ok |
| | Vorgang löschen: | | delete action |
| FIG. 2: | — | No further terms | — |
| FIG. 3: | Datei: | | file |
| | Telefon tagsüber: | | telephone daytime |
| | bereits Kunde: | | is already client |
| | Neuantrag: | | new application |
| | Änderung zur Vers.-Nummer: | | change to insurance number |
| | Hilfe: | | help |
| FIG. 4: | Dokumentanzeige integriert: | | document display integrated |
| FIG. 5: | — | No further terms | — |
| FIG. 6: | — | No further terms | — |

1. Method of ergonomically coordinating associated information fields of at least two applications (1, 2) of a piece of computer software which can be opened dependently on one another or independently of one another and displayed together on a screen, the first application (1) being a graphic display of a digitalised document, particularly a form with defined information fields, and the second application (2) being a dialogue-oriented application with information fields associated with the information fields of the first application, characterised in that information fields of the first application (1) are automatically positioned in a window (1a) generated by the first application, as a function of an information field of the second application (2) which is being processed.

2. Method according to claim 1, characterised in that the information fields of the second application (2) are highlighted by means of a focus, particularly a cursor (17) and/or a voice-controlled focus, while, in particular, semantic context areas of the information or information fields can be used and/or can be defined by the user.

3. Data processing system for carrying out the method according to one of claims 1 and 2, with means for simultaneously opening at least two applications (1, 2) of a piece of computer software, the first application (1) being a graphic display of a digitalised document, particularly a form comprising defined information fields, and the second application (1) being a dialogue-oriented application for inputting and/or reproducing and/or processing information which is to be assigned to the digitalised document, wherein means are provided for generating a window (1a) by means of the first application, in which the information fields of the first application which are to be displayed are capable of being displayed, characterised by means for automatically positioning information fields of the first application in the window (1a) as a function of information fields of the second application (2) which are being processed.

4. Data processing system according to claim 3, characterised by a cursor (17) for highlighting the information or information fields of the second application (2).

5. Computer programme with computer programme coding means which are set up so that they perform all the steps of at least one of the preceding claims 1 or 2 when the programme is running on a computer.

6. Computer programme according to claim 5 which is provided on a computer-readable medium.
